(19) United States
(12) Patent Application Publication
(10) Pub. No.: US 2025/0322177 A1
(43) Pub. Date: Oct. 16, 2025

(54) GUIDING A MACHINE LEARNING MODEL IN GENERATING RULES FOR DATA PROCESSING

(71) Applicant: Ab Initio Technology LLC, Lexington, MA (US)

(72) Inventors: Dusan Radivojevic, North Andover, MA (US); Robert Parks, Weston, MA (US); Fred Gracely, Lexington, MA (US); Drew Polstra, Somerville, MA (US); Sam Wilkins, Cambridge, MA (US); Nour Elmaliki, Somerville, MA (US)

(21) Appl. No.: 19/174,721

(22) Filed: Apr. 9, 2025

Related U.S. Application Data
(60) Provisional application No. 63/632,278, filed on Apr. 10, 2024.

(51) Int. Cl. G06F 40/40; G06F 16/242; G06F 40/279; G06F 40/30

(52) U.S. Cl. CPC G06F 40/40; G06F 16/243; G06F 40/279; G06F 40/30

(57) ABSTRACT

A method implemented by a data processing system for dynamically and automatically guiding a machine learning model in generating a rule from natural language content by controlling the machine learning model to select from candidates that will enable the rule to operate efficiently includes: receiving, by a data processing system, natural language content specifying one or more criteria, identifying candidates for generating a rule representing at least one of the criteria specified by the natural language content, providing the identified candidates and at least a portion of the natural language content to a machine learning model, receiving an indication of at least one of the candidates selected by the machine learning model, generating the rule using the at least one of the candidates selected by the machine learning model, and storing, in a data store, the generated rule.

### CROSS-REFERENCE TO RELATED APPLICATIONS

This application claims priority under 35 U.S.C. § 119 (e) to U.S. Provisional Patent Application No. 63/632,278, filed on Apr. 10, 2024, the entire contents of which are hereby incorporated by reference.

### TECHNICAL FIELD

This disclosure relates to techniques for enabling a data processing system to dynamically and automatically guide a machine learning model in generating a rule, control or other logic from natural language content.

### BACKGROUND

Modern data processing systems manage vast amounts of data within an enterprise. A large enterprise, for example, may have millions of datasets. These datasets can support multiple aspects of the operation of the enterprise. Complex data processing systems typically process data in multiple stages, with the results produced by one stage being fed into the next stage. The overall flow of information through such systems may be described in terms of a directed dataflow graph, with nodes or vertices in the graph representing components (either data files or processes), and the links or “edges” in the graph indicating flows of data between the components. A system for executing such graph-based computations is described in U.S. Pat. No. 5,966,072, titled “Executing Computations Expressed as Graphs,” incorporated herein by reference.

Often times, an enterprise needs to govern or otherwise manage its data in order to, for example, ensure high data quality and regulatory compliance. In some cases, data governance requirements are specified in natural language documents (e.g., regulatory documents or statutes), which can be lengthy and can change over time.

### SUMMARY

In general, in a first aspect, a method implemented by a data processing system for dynamically and automatically guiding a machine learning model in generating a rule from natural language content by controlling the machine learning model to select from candidates that will enable the rule to operate efficiently includes: receiving, by a data processing system, natural language content specifying one or more criteria; identifying, by a data processing system, candidates for generating a rule representing at least one of the one or more criteria specified by the natural language content; providing, by a data processing system, the identified candidates and at least a portion of the natural language content to a machine learning model; receiving, by a data processing system, an indication of at least one of the candidates selected by the machine learning model; generating, by a data processing system, the rule using the at least one of the candidates selected by the machine learning model; and storing, in a data store, the generated rule.

In a second aspect combinable with the first aspect, the candidates include first candidates, the method including: identifying, based on the at least one of the first candidates selected by the machine learning model, second candidates for generating the rule representing the at least one of the one or more criteria specified by the natural language content; providing the identified second candidates to the machine learning model; receiving an indication of at least one of the second candidates selected by the machine learning model; and generating the rule using the at least one of the first candidates and the at least one of the second candidates selected by the machine learning model.

In a third aspect combinable with the first or second aspects, identifying the second candidates for generating the rule includes: querying a domain model for the second candidates based on one or more attributes of the at least one of the first candidates selected by the machine learning model; and receiving the second candidates in response to the query.

In a fourth aspect combinable with any of the first through third aspects, the method includes: determining at least one first characteristic of the at least one of the first candidates selected by the machine learning model; determining at least one second characteristic that is associated with the at least one first characteristic; and identifying, using the domain model and from a plurality of candidates, the second candidates based on the at least one second characteristic, where each of the second candidates are associated with the at least second characteristic.

In a fifth aspect combinable with any of the first through fourth aspects, the candidates for generating the rule specify at least one of a value, an operator, an operand, or a function.

In a sixth aspect combinable with any of the first through fifth aspects, identifying the candidates for generating the rule includes: determining a context of the at least one of the one or more criteria specified by the natural language content; filtering a plurality of candidates based on the context; and identifying, from the filtered plurality of candidates, the candidates for generating the rule.

In a seventh aspect combinable with any of the first through sixth aspects, the context is determined based on information received from the machine learning model or based on semantic analysis of the natural language content.

In an eighth aspect combinable with any of the first through seventh aspects, identifying the candidates for generating the rule includes: querying a metadata model for one or more items of metadata, where the one or items of metadata specify a semantic meaning of data; and receiving the one or more items of metadata in response to the query, where the candidates for generating the rule include the one or more items of metadata.

In a ninth aspect combinable with any of the first through eighth aspects, the method includes: based on the natural language content, generating a prompt for the machine learning model, with the prompt specifying the candidates for generating the rule; and providing the prompt to the machine learning model.

In a tenth aspect combinable with any of the first through ninth aspects, the method includes: receiving, from the machine learning model, a request for information associated with one or more of the candidates; and providing, to the machine learning model, the requested information.

In an eleventh aspect combinable with any of the first through tenth aspects, the method includes: generating user interface data that when rendered on a display device displays a user interface with a visual representation of the generated rule.

In a twelfth aspect combinable with any of the first through eleventh aspects, the method includes: receiving a request to edit the generated rule; and in response to the request, generating second user interface data that when rendered on a display device displays a second user interface including one or more valid choices for editing the rule.

In a thirteenth aspect combinable with any of the first through twelfth aspects, the one or more valid choices specify one or more of the candidates for generating the rule.

In a fourteenth aspect combinable with any of the first through thirteenth aspects, the method includes updating a metadata model to associate the generated rule with an item of metadata associated with the at least one of the candidates identified.

In a fifteenth aspect combinable with any of the first through fourteenth aspects, updating the metadata model includes: adding, to the metadata model, a node representing the generated rule and an edge linking the node to another node representing the item of metadata.

In a sixteenth aspect combinable with any of the first through fifteenth aspects, the metadata model includes a plurality of data structures stored in data storage, where the node includes a first one of the data structures representing the generated rule, and the edge includes a reference in the first one of the data structures to a second one of the data structures representing the item of metadata.

In a seventeenth aspect combinable with any of the first through sixteenth aspects, the method includes: receiving a data processing specification that specifies at least one item of data; identifying, based on the metadata model, that the at least one item of data is associated with the item of metadata associated with the generated rule; and updating the data processing specification to include the generated rule.

In an eighteenth aspect combinable with any of the first through seventeenth aspects, the method includes: generating an executable computer program based on the updated data processing specification; and executing the executable computer program to process the at least one item of data in accordance with the generated rule.

In a nineteenth aspect combinable with any of the first through eighteenth aspects, the machine learning model includes a large language model.

In general, in a twentieth aspect, a method implemented by a data processing system for dynamically and automatically guiding a large language model in generating a rule from natural language content includes: receiving a digital resource with natural language content specifying one or more criteria; based on the digital resource, identifying, based on a metadata model, one or more values that are each a candidate for a large language model to use in generating a rule from the digital resource; providing the one or more candidate values and the digital resource to the large language model; receiving, from the large language model, a rule generated using at least one of the candidate values, the rule representing at least one of the one or more criteria specified by the natural language content; and updating the metadata model to associate the generated rule with an item of metadata representing the at least one of the candidate values used in generating the rule.

In a twenty-first aspect combinable with the twentieth aspect, operations of the method include: storing a metadata model specifying attributes of domains and values of the attribute, and based on the digital resource, identifying a given domain of the domains, where identifying the one or more values that are each a candidate for a large language model to use in generating a rule from the digital resource includes: identifying one or more attributes of one or more values of the domain.

In a twenty-second aspect combinable with the twentieth or twenty-first aspects, receiving the rule generated using at least one of the candidate values includes receiving, from the large language model, one or more rule parameters, and the method includes: generating, based on the one or more rule parameters, the rule representing at least one of the one or more criteria specified by the natural language content.

In a twenty-third aspect combinable with any of the twentieth through twenty-second aspects, the candidate values include first candidate values, and the method includes: receiving, from the large language model, selection data specifying at least one of the first candidate values; identifying, based on a metadata model and the at least one of the first candidate values, one or more second values that are each a candidate for the large language model to use in generating the rule from the digital resource; and providing the one or more second candidate values to the large language model.

In a twenty-fourth aspect combinable with any of the twentieth through twenty-third aspects, operations of the method include identifying, based on the metadata model, one or more questions to ask the large language model to answer to guide generation of the rule from the digital resource; generating one or more prompts to the large language model based on the one or more questions and the one or more candidate values; and providing the one or more prompts to the large language model.

In a twenty-fifth aspect combinable with any of the twentieth through twenty-fourth aspects, the one or more candidate values includes at least one of a source value, and operator value, or an operand value.

In a twenty-sixth aspect combinable with any of the twentieth through twenty-fifth aspects, the one or more candidate values include one or more items of logical metadata included in the metadata model.

In a twenty-seventh aspect combinable with any of the twentieth through twenty-sixth aspects, operations of the method include generating user interface data configured to cause a user interface to display the generated rule.

In a twenty-eighth aspect combinable with any of the twentieth through twenty-seventh aspects, operations of the method include: receiving a request to edit the generated rule, and in response to the request, updating the user interface to display one or more valid choices for editing the rule.

In a twenty-ninth aspect combinable with any of the twentieth through twenty-eighth aspects, the one or more valid choices correspond to the one or more candidate values.

In a thirtieth aspect combinable with any of the twentieth through twenty-ninth aspects, updating the metadata model includes: adding, to the metadata model, a node representing the generated rule and an edge linking the node to another node representing the item of metadata.

In a thirty-first aspect combinable with any of the twentieth through thirtieth aspects, operations of the method include: receiving a data processing specification specifying at least one item of data; identifying, based on the metadata model, that the at least one item of data is associated with the item of metadata associated with the generated rule; and modifying the data processing specification to include the generated rule.

In a thirty-second aspect combinable with any of the twentieth through thirty-first aspects, operations of the method include: generating an executable computer program based on the modified specification; and executing the executable computer program to process the at least one item of data in accordance with the generated rule.

In a thirty-third aspect combinable with any of the first through thirty-second aspects, operations of the method include: receiving an indication of a selected one of the candidate values from the large language model; and identifying a next one of the prompts to ask the large language model; and providing the next prompt to the large language model.

In a thirty-fourth aspect combinable with any of the first through thirty-third aspects, identifying a next one of the prompts includes: transmitting a query to a domain model to select a next prompt, said query including the received indication; and receiving, from the domain model, an indication of the next prompt.

In a thirty-fifth aspect combinable with any of the first through thirty-fourth aspects, the method includes: providing the received indication to a guided expression editor for generating user interface (UI), data that causes a client device to update a guided user interface with the selected source value of the indication.

In a thirty-sixth aspect combinable with any of the first through thirty-fifth aspects, where the node is stored as a data structure, in particular where the data structure conforms to a predefined data model.

In a thirty-seventh aspect combinable with any of the first through thirty-sixth aspects, modifying the data processing specification includes inserting one or more operations to check whether a record of data has a value that complies with the generated rule.

In general, in a thirty-eighth aspect, a method includes: storing information in a standardized format about one or more rules to be applied to data stored in a plurality of network-based non-transitory storage devices; providing remote access to one or more users over a network so that any one of the one or more users can update the information about the one or more rules to be applied to data in real time through a graphical user interface, where the one of the one or more users provides the updated information in a non-standardized format; converting, by a data processing system, the non-standardized updated information into the standardized format by: identifying candidates for generating, in the standardized format, a rule representing one or more criteria specified in the updated information; providing the identified candidates and at least a portion of the updated information to a machine learning model; receiving an indication of at least one of the candidates selected by the machine learning model; and generating the rule in the standardized format using the at least one of the candidates selected by the machine learning model; storing the standardized updated information about the one or more rules to be applied to the data stored in the plurality of network-based non-transitory storage devices; automatically generating an indication including the standardized updated information about the one or more rules to be applied to the data whenever standardized updated information is stored; and transmitting the indication to update a metadata model with the standardized updated information about the one or more rules so that each of the one or more users have access to up-to-date information about the one or more rules.

In a thirty-ninth aspect combinable with the thirty-eighth aspect, the method includes: automatically generating and executing executable instructions in accordance with the standardized updated information about the one or more rules whenever updated information is stored to apply the one or more rules to data; and responsive to the executing, transmitting to the one or more network-based non-transitory storage devices updated data in accordance with the standardized updated information about the one or more rules so that the one or more users have near real-time access to data that is in accordance with the one or more rules.

In general, in a fortieth aspect, a system for processing data includes one or more processors; and one or more computer-readable storage devices storing instructions executable by the one or more processors to perform the method of any of the first through thirty-ninth aspects.

In general, in a forty-first aspect, a non-transitory computer-readable storage medium stores instructions executable by one or more processors to cause the one or more processors to perform the method of any of the first through thirty-ninth aspects.

In general, in a forty-second aspect, a computer program includes instructions that are executable by one or more computers to cause the one or more computers to perform the method of any of the first through thirty-ninth aspects.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One or more of the above aspects may provide one or more of the following advantages.

Data governance requirements are often specified in lengthy natural language documents that can change over time. As a result, distilling these requirements into functional data governance controls or rules is a difficult and time-consuming process that must be repeated each time the requirements change. Further compounding this issue is the fact that the physical data (e.g., datasets and data elements) that needs to be governed continuously grows over time. However, governing this physical data through controls or rules defined at the physical level (e.g., dataset or data element level) is unsustainable and costly. This is because—for each new physical dataset—new logic would need to be defined to govern that new physical dataset, creating a continuous and expensive cycle of constantly defining new rules that must be updated each time the requirements change.

The techniques described here enable a data processing system to dynamically and automatically guide a large language model (LLM) in generating a rule, control or other logic from natural language content. Specifically, the data processing system can generate a series of prompts using the natural language content and constraints obtained from one or more metadata models to guide the LLM forming the rule (or part of the rule). A guided user interface provided by the data processing system can enable a user to view, test, modify, and/or approve the rule in an intuitive (e.g., no-code) manner. Once the rule is approved, the data processing system can automatically incorporate the rule into a metadata model for use in metadata-driven processing of physical data. In this way, the techniques described here enable rules for governing physical data to be quickly and efficiently created from natural language content, while providing transparency to allow validation and modification of the rule in self-service and syntax-error-free manner. Furthermore, the metadata model gets more efficient in identifying candidate values for the LLM over time as rules are extracted and added to the metadata model. Once integrated, the rules can be applied both for supporting the identifying of rules in natural language content and for analyzing data that is subjected to rules.

In some examples, the generated rules or controls are defined at a logical level (e.g., a conceptual level representing a semantic meaning of underlying physical data). These rules are then automatically propagated down to physical datasets-including existing datasets and new datasets added into the system at a later time (e.g., after the rule has been defined). As such, new rules do not need to be defined for each new dataset that is added into a system. Once an entity has done the upfront work of defining all of the rules needed to govern various datasets, the system described here automatically applies those rules to new and existing datasets-making governance efficient. This is because logical concepts and their associated rules tend to stabilize over time. So, once the rules have been defined for governance, the system can automatically apply these rules to new datasets, without new controls having to be defined. In this way, the techniques described here perform physical data governance more efficiently and with less resource consumption relative to systems that perform governance by defining rules or controls individually for each physical dataset.

The techniques described here establish a technical effect in that they provide an efficient implementation of generating rules for large-scale data analysis. Specifically, the metadata model (and/or other models) are used for two purposes. First, the metadata model provides support in identifying one or more values that are each a candidate for the large language model. Second, the metadata model is subjected to a learning process in that it is updated with the rule generated from the at least one candidate value; this second purpose amounts to a self-learning effect that improves the metadata model and prepares it for applying rules, including the rule that is updated in the metadata model, to subsequently received data. Hence, a two-fold effect is achieved that provides efficient interpretation, as well as application, of rules.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIGS. 1A and 1B are diagrams of an example system for guiding a machine learning model to generate rules for data processing.

FIGS. 2A-2K are diagrams of the system of FIGS. 1A and 1B in stages of generating a rule.

FIGS. 3A and 3B are diagrams of the system of FIGS. 1A and 1B in stages of applying a rule.

FIG. 4 is a diagram of an example system for guiding a machine learning model to generate rules for data processing.

FIGS. 5 and 6 are flow diagrams of example processes for guiding a machine learning model to generate rules for data processing.

FIG. 7 is a diagram showing details of a computer system, such as a data processing system.

### DETAILED DESCRIPTION

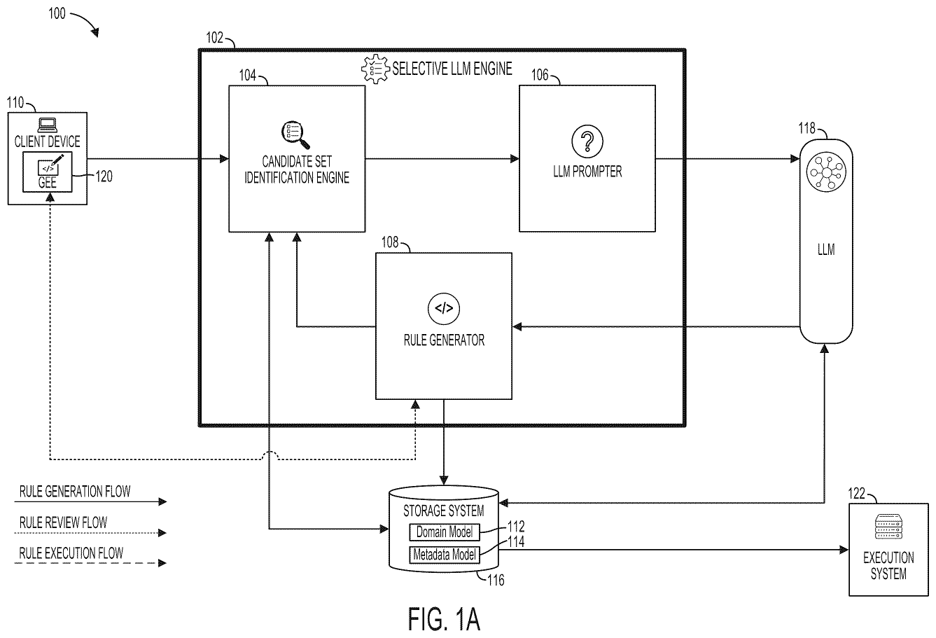

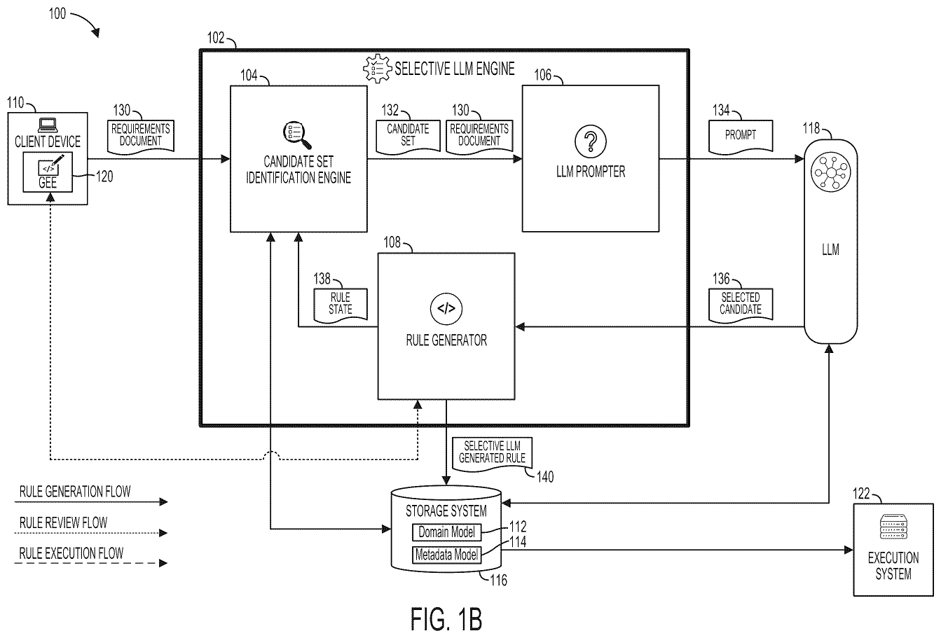

Referring to FIG. 1A, a system 100 is shown for guiding a machine learning model, such as a large language model (LLM), in generating a rule from natural language content. In this example, system 100 includes a selective LLM engine 102, which in turn includes a candidate set identification engine 104, an LLM prompter 106, and a rule generator 108. The candidate set identification engine 104 is configured to identify a set of candidates for generating a rule, control, or other logic to process data in accordance with criteria specified in a natural language format (e.g., by a client device 110). As described herein, these candidates represent a set of valid rule elements (e.g., values, operators, operands, and/or functions, among other data) within the system 100 and are identified using one or more models, such as a domain model 112 and/or a metadata model 114 stored in a storage system 116. The LLM prompter 106 is configured to generate a prompt that guides an LLM 118 to select one or more of the identified candidates to be used in generating the rule.

The rule generator 108 is configured to generate the rule based on the candidate(s) selected by the LLM 118. In some examples, the rule generator 108 updates a rule state based on the candidate(s) selected by the LLM 118, and provides the rule state to the candidate set identification engine 104 to identify an additional set of candidates for generating the rule. As the rule is generated, the rule generator 108 provides the rule to a guided expression editor (GEE) 120 of the client device 110 to enable a user of the client device 110 to view, test, modify, and/or approve the rule in an intuitive (e.g., no-code) manner. Once the rule is approved, the rule generator 108 incorporates the rule into the metadata model 114 for use in metadata-driven data processing, as described below.

An execution engine 122 of the system 100 interacts with the metadata model 114 to generate and execute a computer program that processes data in conformance with the generated rules. For example, the execution engine 122 can receive a specification (e.g., a data processing specification) and can interact with the metadata model 114 (e.g., using one or more queries) to identify rule(s) that are applicable to data specified in the specification. The execution engine 122 updates the specification with the identified rules and generates an executable computer program from the updated specification. Once generated, the execution engine 122 can execute the program to retrieve data from storage, process the data in accordance with the specification including the identified rules, and store the processed data to which the rules are applied.

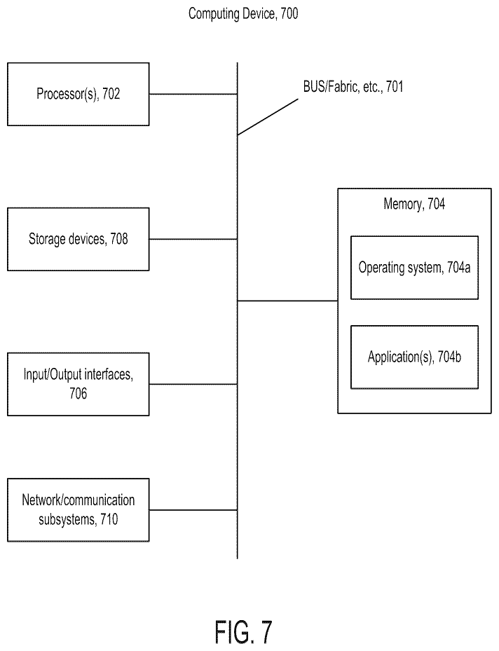

Referring to FIG. 1B, in operation, the candidate set identification engine 104 of the selective LLM engine 102 receives a requirements document 130 from the client device 110, which can be a data processing system, or any other system configured to provide the requirements document. In general, the requirements document 130 can be any digital resource that includes natural language content specifying one or more requirements or criteria for processing data. Examples of the requirements document 130 include, but are not limited to, regulatory documents, business write-ups, statutes, data governance publications, and descriptions. In some examples, the client device 110 (among other client devices) is provided with remote access to the selective LLM engine 102 over a network (e.g., the network/communication subsystems 710 shown in FIG. 7) so that user(s) of any of the client device(s) can provide the requirements document 130 in real or near-real time through a graphical user interface. The requirements document can specify, in a non-standardized (e.g., natural language) format, new and/or updated information about one or more rules to be applied to data.

Upon receipt of the requirements documents 130, the candidate set identification engine 104 identifies a set of candidates 132 for generating a rule representing the criteria specified in the requirements document. In general, a rule includes one or more clauses or conditions for data to satisfy. In some examples, each rule clause or condition is defined according to rule elements. In some examples, a rule can include or be associated with one or more actions to be taken when the rule is (or is not) satisfied. The rules are applied to physical entities, such as data fields in records of datasets, thus contributing to accelerated analysis of these data fields, in a physical or technical sense. Note that while the examples provided herein describe the generation and application of rules (and, more specifically, data governance and data quality rules), the techniques described herein can be used to generate and apply other rules, controls, expressions, or logic in some examples.

To identify the set of candidates 132, the candidate set identification engine 104 queries the domain model 112 and/or other models, such as the metadata model 114. In general, the domain model 112 is a data structure that includes nodes representing the possible elements of a rule within a given domain (e.g., a data quality domain, a data validation domain, etc.). Each node can be a data object or other data structure that includes attributes for the element it represents. The values of some attributes are dynamically populated as the rule is generated based on, e.g., selections by the LLM 118.

Other attributes can have predefined values that specify, for a given element, the valid prior and/or subsequent elements. In this manner, the domain model 112 informs the candidate set identification engine 104 of the possible candidates for rule element(s) at any point during the construction of the rule.

In some examples, the domain model 112 includes nodes representing value elements and operator elements. Value elements are those that contain a value, such as a literal value (e.g., “3” or “hello”), a reference value (e.g., a reference to a logical field name, such as “Remaining Balance”), or an expression syntax (e.g., “(RemainingBalance/TotalBalance)*100)”). In some examples, a value includes a value category (e.g., literal, reference, expression_syntax, object, etc.) and one or more value types (e.g., string, number, percentage, etc.).

Operator elements are those that contain an operator, such as a test operator (e.g., “less than,” “equals,” or “starts_with”), a function operator (e.g., “length_of”), or a join operator (e.g., “OR” or other logic used to join conditions and/or clauses within a rule). Operator elements can make decisions about a value, transform a value, or logically join conditions. Operator elements also declare (e.g., via attribute values) what categories and/or value types they can act upon, what arguments they support to configure their execution, and what value type they produce.

By defining possible elements and matching value category and value type requirements between elements (among other requirements), the domain model 112 can provide a set of candidates for any given element of a rule. This allows the domain model 112 to respond to queries like:
“What categories of values are available for source inputs?” (e.g., reference, formula, metadata attribute, function, etc.)
“What operators are available given the source value selected?”
“What operands must be populated to complete the chosen operator?” “What categories of values are available for each of the operands?”

In some examples, domain model 112 contains the definition of value types, value categories, operators, operands, classification to value type mappings, and queries to other models, such as the metadata model 114, among other data. In some examples, the queries to the metadata model 114 can be entity application programming interface (API) queries, such as those described in U.S. patent application Ser. No. 17/587,181, titled “Systems and methods for accessing data entities managed by a data processing system,” the entire content of which is hereby incorporated by reference. In this manner, the domain model 112 can provide a set of candidates 132 based on embedded data and/or queries to other models (e.g., queries to the metadata model 114 for available sources values, such as available business data elements or other technical or logical metadata) that can be used to guide the LLM's generation of a rule. This then makes a “chat” between the selective LLM engine 102 and the LLM 118 possible. The domain model 112 is asked for a set of candidates 132, which are then used (along with the requirements document 130) by the LLM prompter 106 to generate a prompt 134 to the LLM 118. Responsive to the prompt, the LLM 118 selects a candidate 136, and the rule generator 108 incorporates the selected candidate 136 into the rule state 138. In some examples, rule generator 108 passes the rule state 138 to the candidate set identification engine 104, which uses the rule state to query the domain model 112 for “what's next.” This pattern continues until a rule specifying the requirements or criteria in the requirements document is generated per the LLM's determination. In this manner, the selective LLM engine 102 converts the non-standardized information (e.g., criteria) specified in the requirements document into a standardized format represented by the candidates.

Upon receipt of a selection from the LLM 118, the rule generator 108 passes the rule state (or UI data specifying the rule state) to the GEE 120 of the client device 110. The GEE 120 uses the rule state (or UI data) to populate a guided user interface displayed at the client device 110, thereby enabling a user of the client device 110 to view the rule generation in real or near-real time. Once the rule is complete (e.g., per the LLM's determination), the GEE 120 can provide the proposed rule and an option to test, modify, and/or approve the rule via the guided user interface displayed at the client device 110. In some examples, the guided user interface enables the user to test, edit, and approve the rule without writing code (e.g., by presenting valid choices for editing the rule, rather than requiring the user to write or edit the rules underlying code), thereby avoiding syntax errors.

When the rule is approved, the rule generator 108 incorporates the selective LLM generated rule 140 into the metadata model 114. In general, the metadata model 114 is a structured representation of metadata and relationships among the metadata. For example, the metadata model (also referred to herein as a metadata schema) can be an object model or a data structure (e.g., a schema) that includes nodes representing items of metadata (e.g., technical or logical metadata) and edges representing relationships among the items of metadata. In general, technical metadata includes metadata that describes attributes of stored data, such as its technical name (e.g., dataset name, field name, etc.). For example, technical metadata includes data describing a dataset in its raw or source form, e.g., names of fields included in a dataset in its raw form. Logical metadata includes metadata that gives meaning or context to data, such as its semantic or business name.

A node can be a data object or other data structure that includes values for attributes of the item of metadata that it represents. The attributes included in a node can depend on the type or class of metadata that the node represents. For example, a node representing a dataset can include a dataset name attribute that is populated with the name of the dataset that the node represents.

An edge can be a reference, a pointer, a data object, or another data structure that specifies a relationship between nodes. In some examples, an edge can represent a hierarchical relationship between nodes (e.g., a parent-child relationship), such as a relationship between a dataset node (the parent) and a node of a technical data element it contains (the child). As another example, an edge can represent an associative relationship between nodes, such as a relationship between a technical data element node and a business data element node that describes or gives meaning to the technical data element node. The relationships between technical metadata and logical metadata can be specified or identified through semantic discovery, such as described in U.S. patent application Ser. No. 16/794,361, titled “Discovering a Semantic Meaning of Data Fields from Profile Data of the Data Fields,” the entire content of which is incorporated herein by reference.

A rule can include or otherwise be associated with an item of logical metadata (or technical metadata). Thus, to incorporate the rule 140 into the metadata model 114, the rule generator 108 can link the rule with an item of logical metadata (or technical metadata) in the metadata model 114. For example, the rule generator 108 can provide instructions to update the metadata model 114 to include a node representing the rule and one or more edges linking the node to the logical metadata (or technical metadata) associated with the rule. Once a rule is incorporated into the metadata model 114, it can be used (e.g., by the execution engine 122) for processing physical data, as described herein. In some examples, the rule itself is stored in, e.g., the storage system 116 separate from the metadata model 114. The rule can also be transformed into a persistent, expression-free representation in any language, thereby increasing the accessibility of the generated rule.

In some examples, the metadata model 114 stores information in a standardized formatted about one or more rules to be applied to stored data (e.g., data stored in multiple network-based non-transitory storage devices). When a new or updated rule is generated and approved, an indication including the generated rule (e.g., the standardized, updated information about the one or more rules to be applied to the data) is generated and stored in one or more network-based non-transitory storage devices. From here, the indication is transmitted to update the metadata model 114 with the standardized updated information about the one or more rules so that any user accessing the metadata model has access to up-to-date information about the one or more rules.

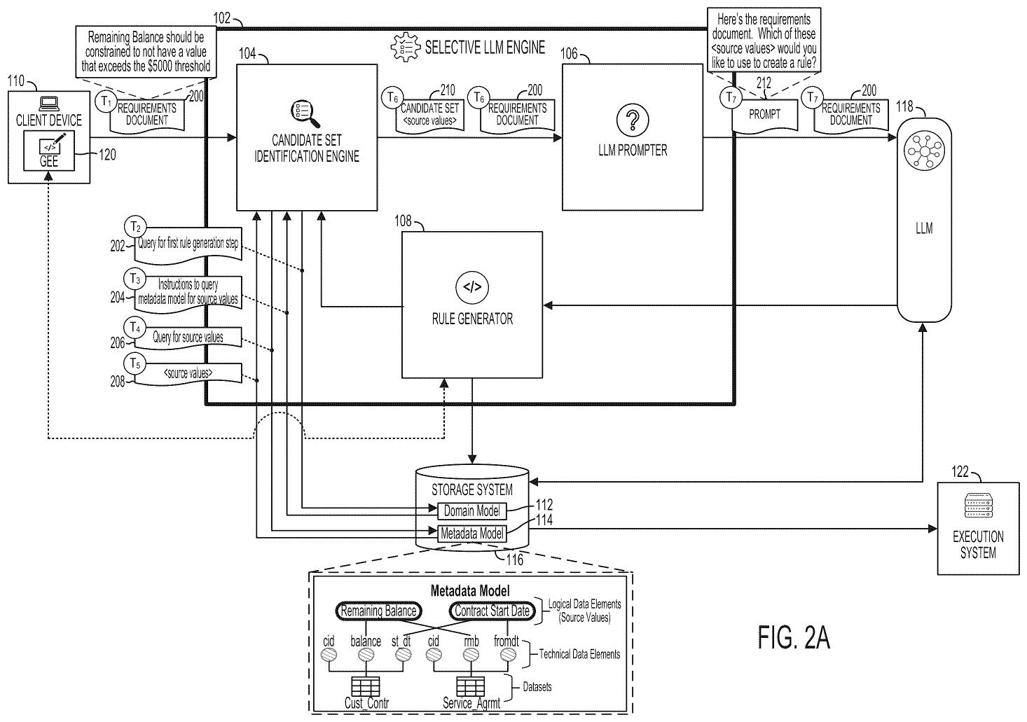

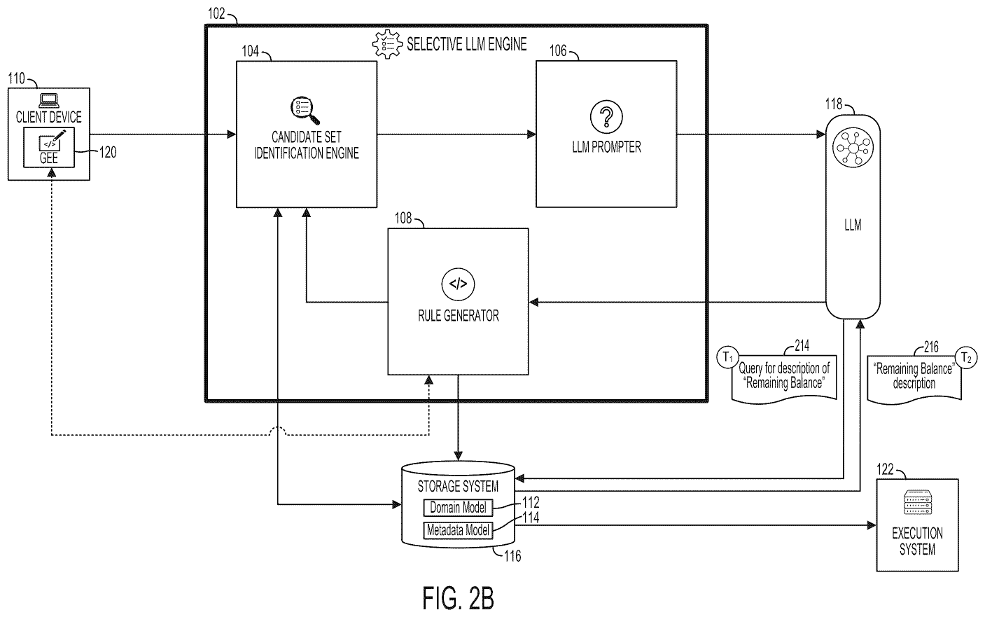

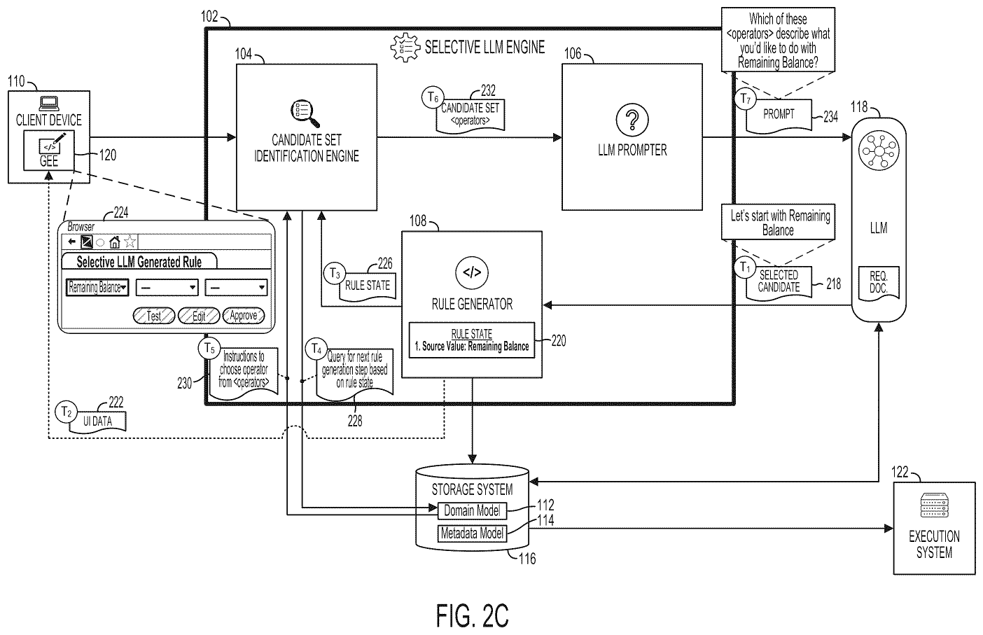

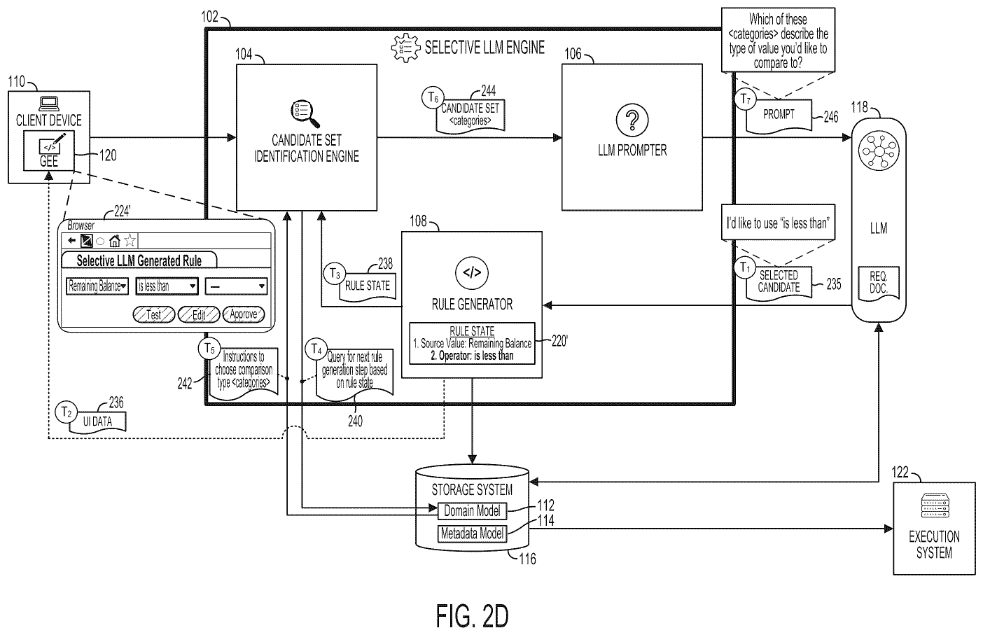

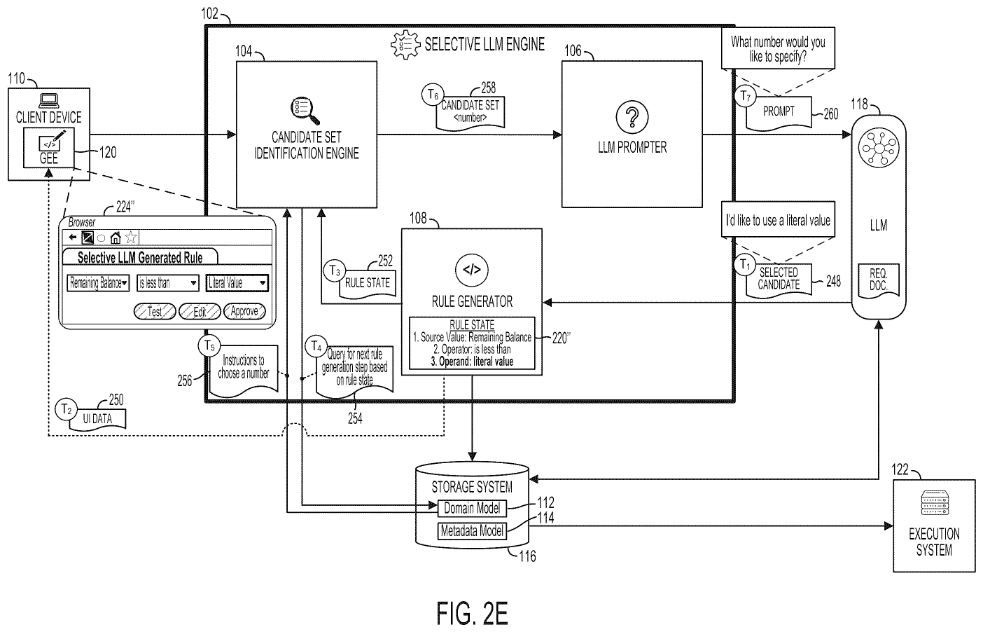

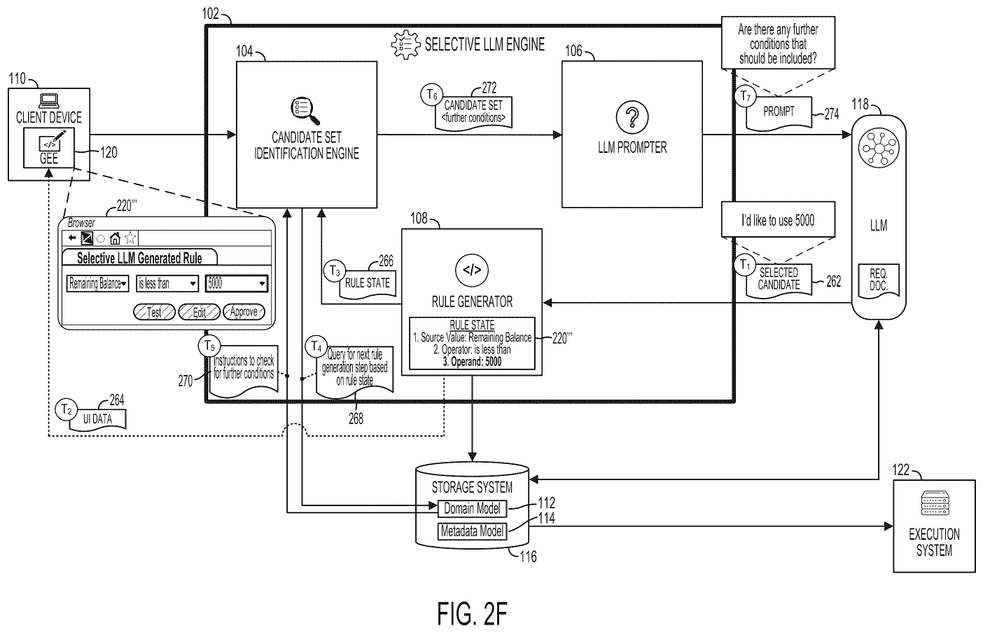

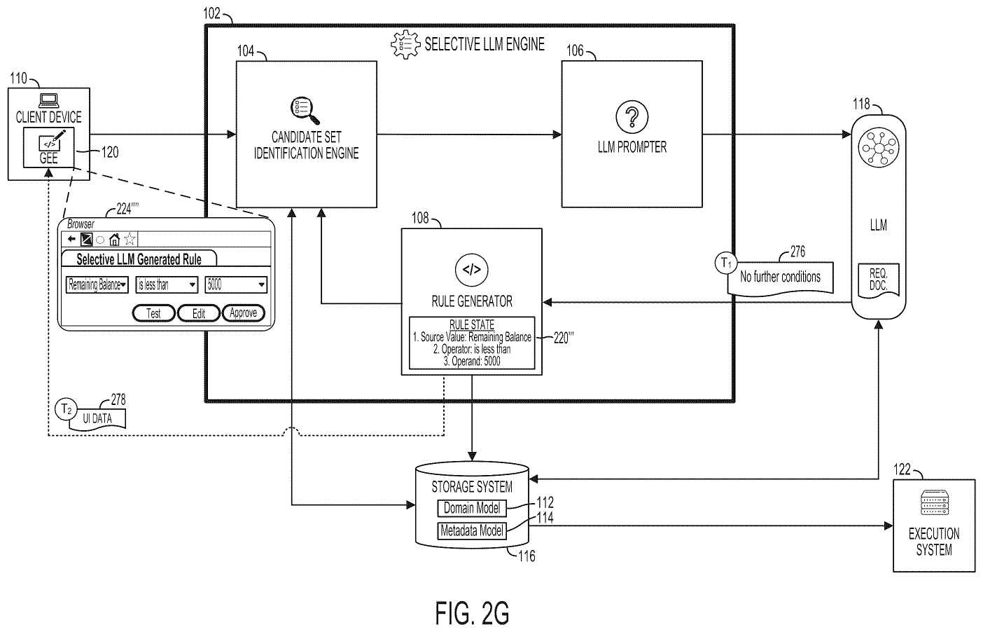

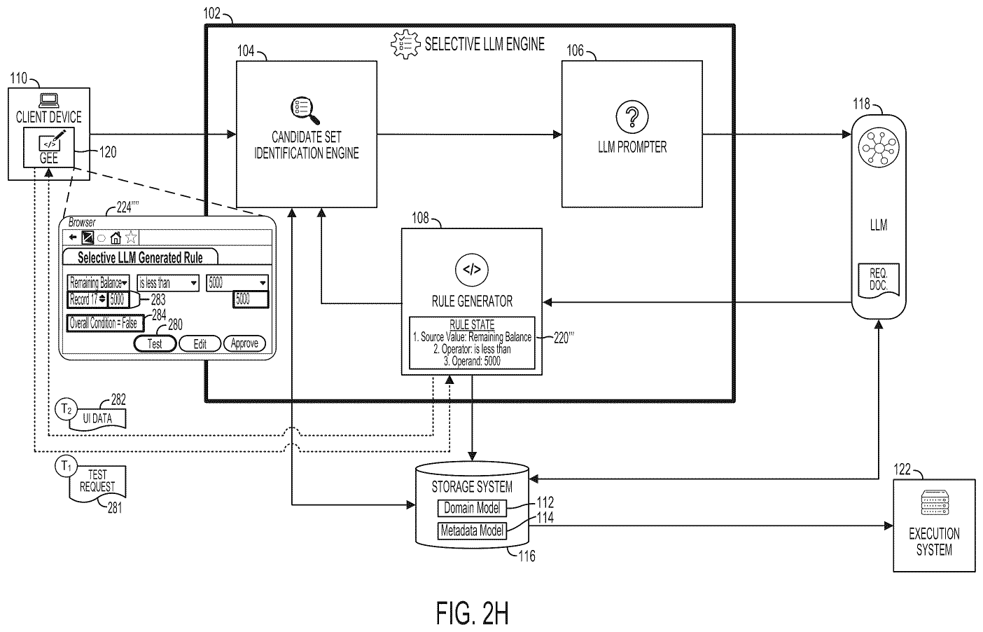

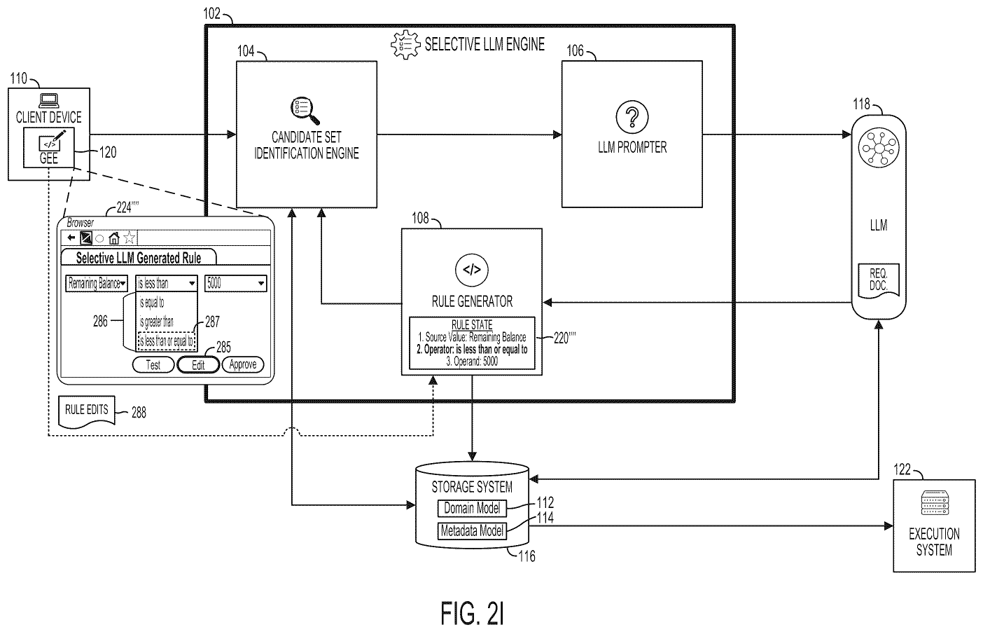

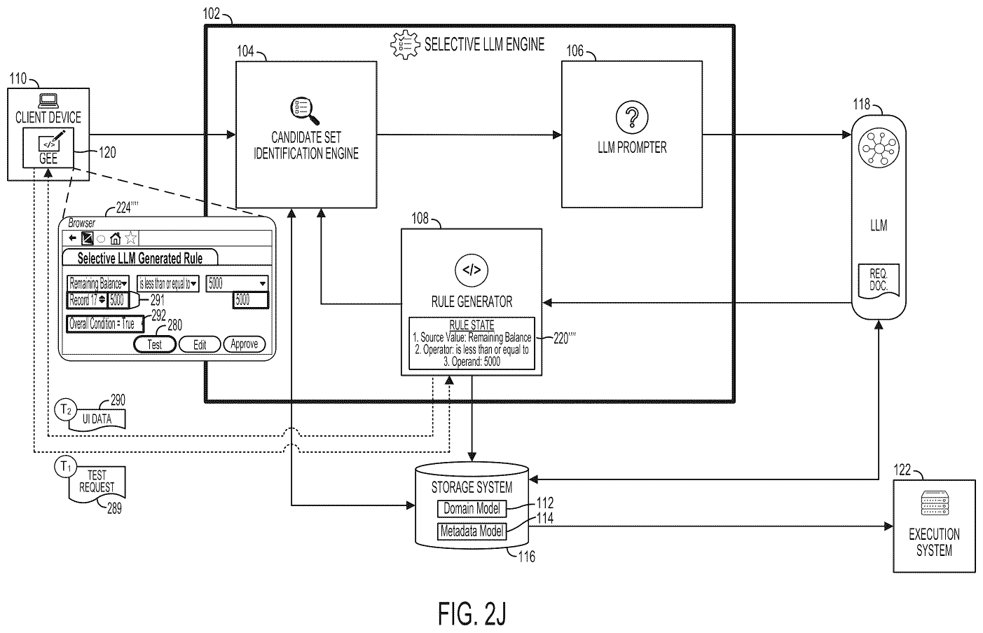

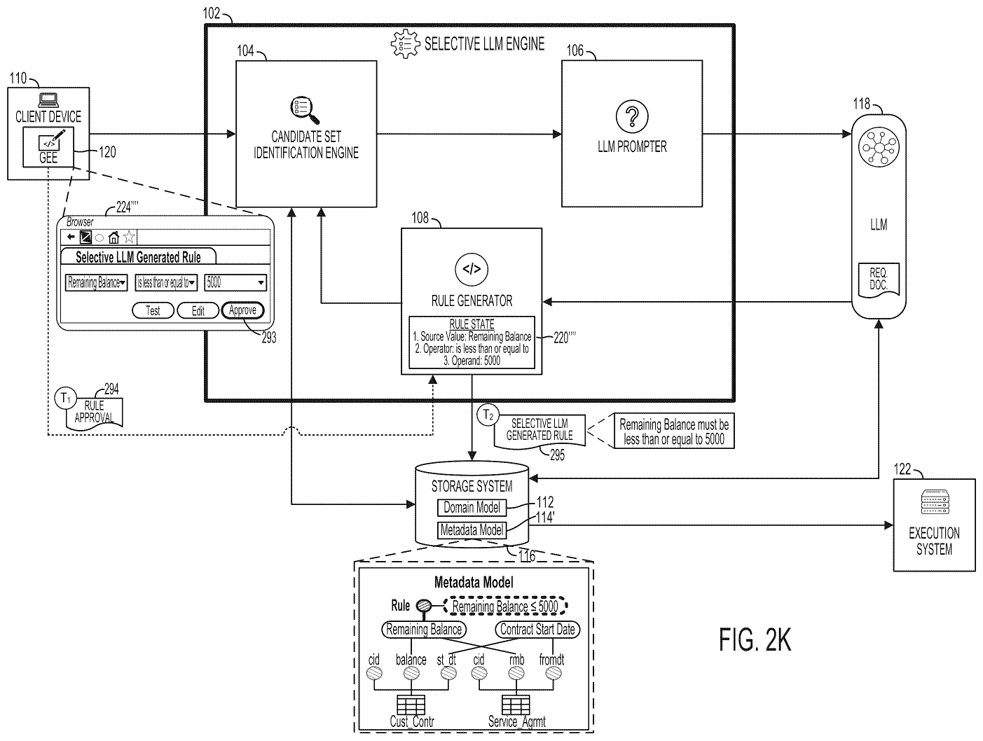

Referring to FIG. 2A, an example of generating data governance rules is shown. Initially, at time T₁, the candidate set identification engine 104 receives a requirements document 200 from the client device 110. In this example, the requirements document specifies a requirement that “Remaining Balance should be constrained to not have a value that exceeds the $5000 threshold.” To generate a rule based on the requirements document 200, the candidate set identification engine 104 sends a query 202 to the domain model 112 for the source values that are available to be considered as candidates. In response to the query 202, the domain model 112 identifies the available source values and returns the identified source values (or instructions to obtain the identified source values) to the candidate set identification engine 104. In some examples, the domain model 112 includes one or more rules that specify the source values that are available as candidates, such as source values of one or more particular value types and/or value categories. For instance, to ensure that the generated rule is defined in terms of logical metadata (and thus is automatically and efficiently applied to any physical data associated with this logical metadata, as described herein), the domain model 112 can be configured to include items of logical data as the available source values. To obtain this logical metadata, the domain model 112 can provide instructions 204 to query the metadata model 114 for some or all of the items of logical metadata (e.g., logical data elements) that it contains. In some examples, the domain model 112 itself (or a system associated with the domain mode 112) can query the metadata model 114 and return the items of logical metadata to the candidate set identification engine 104.

Responsive to the instructions 204, the candidate set identification engine 104 sends a query 206 to the metadata model 114 for some or all of the logical data elements that it contains. In this example, the metadata model 114 contains “Remaining Balance” and “Contract Start Date” as logical data elements, which are returned to the candidate set identification engine 104 as the source values 208 that are available as candidates. Although only two logical data elements are shown, the metadata model 114 can include thousands of logical data elements that are available as source values, with each logical data element being linked to one or more technical data elements. By defining the rule with respect to logical data elements and automatically propagating the rule down to linked technical data elements, the number of rules that need to be defined to process physical data is significantly reduced, thereby increasing the speed and efficiency of processing physical data in accordance with the rules.

After obtaining the source values 208, the candidate set identification engine 104 creates a candidate set 210 containing the sources values 208 and transmits the candidate set 210 along with the requirements document 200 to the LLM prompter 106. Based on the requirements document 200 and the candidate set 210, the LLM prompter 106 generates a prompt 212 to the LLM 118. Here, the prompt 212 asks the LLM 118 to select one or more candidates from the provided candidate set 210 to be used as source value(s) in a rule that represents one or more of the requirements or criteria specified in the requirements document 200. In general, the LLM 118 is a specialized type of artificial intelligence (AI) that has been trained on vast amounts of text to understand existing content and generate original content. In some examples, the LLM is an off-the-shelf LLM, such as OpenAI's Generative Pretrained Transformer (GPT), Google's Bidirectional Encoder Representations from Transformers (BERT), or Meta's Large Language Model Meta AI (LLaMA), among others. The LLM 118 can leverage these capabilities to analyze the prompt 212, the requirements document 200, and the candidate set 210 to identify relevant cues, such as context, keywords, or patterns, guiding it to choose the most appropriate candidate to serve as the source value for the rule.

In some examples, the LLM 118 may need additional information from the selective LLM engine 102 to inform its decision. For example, the LLM 118 may require additional information about the logical data element “Remaining Balance” (e.g., what balance does this refer to, what currency is it measured in, etc.). Referring to FIG. 2B, to obtain this additional information, the LLM 118 can query 214 the metadata model 114 to request data or metadata associated with the “Remaining Balance” logical data element, such as a description of “Remaining Balance.” Responsive to the query 214, the metadata model 114 can return a description 216 of the “Remaining Balance” logical data element. In some examples, the LLM prompter 106 can provide the LLM 118 with instructions for querying the metadata model 114, such as by specifying an application programming interface (API) to obtain information from the metadata model 114. In some examples, the LLM 118 can be configured to query the metadata model 114 through the selective LLM engine 102 in order to control access to data or metadata, thereby improving data security.

After obtaining additional information about the “Remaining Balance” logical data element, the LLM 118 selects 218 “Remaining Balance” as the source value for the rule, as shown in FIG. 2C. The rule generator 108 uses the selected candidate 218 to update a rule state 220 to include “Remaining Balance” as the source value. Based on the rule state 220, the rule generator 108 provides UI data 222 to the GEE 120 of the client device 110 to indicate the current rule state. The GEE 120 uses the UI data 222 to render a guided user interface 224 with the selected source value (i.e., Remaining Balance).

In some examples, the rule generator 108 provides an indication 226 of the rule state 220 to the candidate set identification engine 104 for use in identifying additional candidate sets for generating the rule. The candidate set identification engine 104 then transmits a query 228 to the domain model 112 for the next rule generation step based on the indicated rule state (e.g., “It choose Remaining Balance. What do I ask next?”). In response to the query 228, the domain model 112 determines that the LLM 118 should be prompted for an operator based on, for example, the value category and/or value type of the selected source value, or other rules or data embedded within the domain model 112. For example, the selected “Remaining Balance” source value may be associated with a value category of “reference” and a value type of “literal” within the domain model 112. Accordingly, the domain model 112 may identify (e.g., based on attribute values) operators that are applicable for source operands (e.g., source values) having a value category of “reference” and/or a value type of “literal” (e.g., a “is less than” operator, an “is equal to” operator, etc.), as opposed to operators that are not configured to operate on reference and/or literal values. In this example, the domain model 112 responds to the query 228 with instructions 230 to choose an operator and a list of operators that are available as candidates (e.g., “is equal to,” “is not equal to,” “is less than,” “is greater than,” etc.). Based on the instructions 230, the candidate set identification engine 104 transmits a candidate set 232 including the set of operators to the LLM prompter 106. The LLM prompter 106 generates a prompt 234 asking the LLM 118 to select an operator from the candidate set that should be used on “Remaining Balance.”

Generating prompts and using these prompts to automatically, and without compulsory user interaction, question an LLM allows the selective LLM engine 102 to determine, in an intelligent way, a respective or subsequent item to use in assembling a rule. This approach substantially improves item selection of techniques that would simply iterate over available items, as well as techniques that do not constrain the LLM's choice in any way (which would likely result in choices that are invalid and/or incorrect within the system 100).

Referring to FIG. 2D, the LLM 118 selects 235 the “is less than” operator, which is used by the rule generator 108 to update the rule state 220′. Such a selection is based on the LLM's analysis of the prompt 234 including the candidates in view of the requirements document 200. Based on the updated rule state 220′, the rule generator 108 provides UI data 236 to the GEE 120 of the client device 110 to indicate the current rule state. The GEE 120 uses the UI data 236 to render an updated guided user interface 224′ with the selected operator (i.e., is less than). The rule generator 108 also provides an indication 238 of the rule state 220′ to the candidate set identification engine 104 for use in identifying additional candidate sets for generating the rule. The candidate set identification engine 104 then transmits a query 240 to the domain model 112 for the next rule generation step based on the indicated rule state (e.g., “It chose “is less than.” What do I ask next?”). In response to the query 240, the domain model 112 determines that the LLM 118 should be prompted for a comparison type (e.g., a category or type of an operand, such as a literal value or attribute, to be compared with Remaining Balance). Such a determination is based on, for example, the value category and/or value type of the selected source value, the value categories and/or value types that are applicable for argument operands of the selected operator, or both. In this example, the domain model 112 responds to the query 240 with instructions 242 to choose a comparison type and a list of categories that are available as candidates (e.g., literal value, attribute, function). Based on the instructions 242, the candidate set identification engine 104 transmits a candidate set 244 including the identified categories to the LLM prompter 106. The LLM prompter 106 generates a prompt 246 asking the LLM 118 to select a category from the candidate set that describes the type of value that is to be compared to.

Referring to FIG. 2E, the LLM 118 selects 248 a literal value for the comparison, which is used by the rule generator 108 to update the rule state 220″. Such a selection is based on the LLM's analysis of the prompt 246 including the candidates in view of the requirements document 200. Based on the updated rule state 220″, the rule generator 108 provides UI data 250 to the GEE 120 of the client device 110 to indicate the current rule state. The GEE 120 uses the UI data 250 to render an updated guided user interface 224″ with the selected comparison type (i.e., literal value). The rule generator 108 also provides an indication 252 of the rule state 220″ to the candidate set identification engine 104 for use in identifying additional candidate sets for generating the rule. The candidate set identification engine 104 then transmits a query 254 to the domain model 112 for the next rule generation step based on the indicated rule state (e.g., “It choose literal value. What do I ask next?”). In response to the query 254, the domain model 112 determines that the LLM 118 should be prompted for a number. Such a determination is based on, for example, the value category and/or value type of the selected argument operand. In this example, the domain model 112 responds to the query 254 with instructions 256 to choose a number. Based on the instructions 256, the candidate set identification engine 104 transmits a candidate set 258 specifying that the candidate is a number to the LLM prompter 106. The LLM prompter 106 generates a prompt 260 asking the LLM 118 to select a number that should be used.

Referring to FIG. 2F, the LLM 118 selects 262 a number “5000” for the comparison, which is used by the rule generator 108 to update the rule state 220″″. Such a selection is based on the LLM's analysis of the prompt 260 including the candidate in view of the requirements document 200. Based on the updated rule state 220′″, the rule generator 108 provides UI data 264 to the GEE 120 of the client device 110 to indicate the current rule state. The GEE 120 uses the UI data 264 to render an updated guided user interface 224′″ with the selected number (i.e., 5000). The rule generator 108 also provides an indication 266 of the rule state 220′″ to the candidate set identification engine 104 for use in identifying additional candidate sets for generating the rule. The candidate set identification engine 104 then transmits a query 268 to the domain model 112 for the next rule generation step based on the indicated rule state (e.g., “It specified a value of 5000. What do I ask next?”). In response to the query 268, the domain model 112 determines that there is nothing further to ask the LLM, as the rule (or rule condition) is complete from its perspective. Such a determination can be based on, for example, predefined rules based on the selected source value, operator, and literal value, or other data embedded within the domain model 112. In this example, the domain model 112 responds to the query 268 with instructions 270 to ask the LLM whether there are any further rule conditions. Based on the instructions 270, the candidate set identification engine 104 transmits a candidate set 272 specifying that the candidate is checked for further conditions to the LLM prompter 106. The LLM prompter 106 generates a prompt 274 asking the LLM 118 whether there are any other conditions that should be included in the rule.

Referring to FIG. 2G, the LLM 118 selects 276 that no further conditions are necessary (e.g., the rule is complete). Such a selection is based on the LLM's analysis of the prompt 274 including the candidate in view of the requirements document 200. For example, since the series of selections by the LLM 118 represent the requirement specified in the requirements document 200 (e.g., Remaining Balance should be constrained to not have a value that exceeds the $5000 threshold), and because there are no other requirements specified in the requirements document 200, the LLM 118 determines that no further conditions are necessary. This information is stored by the rule generator 108, such as by indicating that the rule state 220′″ is complete. The rule generator 108 provides UI data 278 to the GEE 120 of the client device 110 indicating the complete rule state. The GEE 120 uses the UI data 278 to render an updated guided user interface 224″″ to enable the ability to test, edit, and/or approve the proposed rule.

FIG. 2H illustrates an example of a user testing the generated rule using the guided user interface 224″″. In this example, the user initiates the test by selecting the test button 280. Once the test is initiated, a test request 281 is sent to the rule generator 108, which returns UI data 282 that populates the guided user interface 224″″ with test data 283, which can be real or synthetic data, as well as a result 284 of evaluating the rule (or condition) against the test data 283. Here, Record 17 has a value of 5000 for Remaining Balance (e.g., because the field of Record 17 corresponding to the logical metadata ‘Remaining Balance’ is 5000). Since 5000 is not less than the literal value 5000, the result 284 of the rule condition is false.

However, as noted above, the requirements document 200 in this example specified that “Remaining Balance should be constrained to not have a value that exceeds the $5000 threshold.” Here, the 5000 Remaining Balance in Record 17 does not exceed the 5000 threshold, so the rule does not accurately reflect the requirement. To correct this error, the user can edit the rule by selecting the edit button 285, as shown in FIG. 2I. The user can then choose a rule element to edit, and the GEE 120 presents the user with valid choices for the rule element based on, e.g., information about the available options provided by the domain model 112 during the rule generation process. In this example, the user chooses to edit the “is less than” operator, and is presented with valid choices 286. Here, the user selects 287 the operator “is less than or equal to” to accurately capture the “does not exceed” requirement. An indication 288 of the rule edits is sent to the rule generator 108, which updates the rule state 220″″ to incorporate the edits.

After editing the rule, the user can test the rule once again to ensure its accuracy, as shown in FIG. 2J. In this example, the user initiates the test by selecting the test button 280. Once the test is initiated, a test request 289 is sent to the rule generator 108, which returns UI data 290 that populates the guided user interface 224″″ with test data 291, which can be real or synthetic data, as well as a result 292 of evaluating the rule (or condition) against the test data 291. Here, the 5000 Remaining Balance of Record 17 is less than or equal to the literal value 5000, so the result 292 of the rule condition is true.

Once the user is satisfied with the rule, the user can choose to approve the rule for use in processing data, as shown in FIG. 2K. Here, the user initiates the approval process by selecting the approve button 293, which causes the client device 110 to send an indication 294 of the rule approval to the rule generator 108. In response to the approval indication 294, the rule generator 108 incorporates 295 (or provides instructions to incorporate) the rule into the metadata model 114′. Specifically, the rule adds a node (e.g., data object or data structure) representing the rule “Remaining Balance≤5000” to the metadata model 114′, and adds an edge (e.g., pointer or reference) linking this node to the “Remaining Balance” item of logical metadata. By defining the rule at the logical level (e.g., with respect to Remaining Balance), the rule will automatically be applied to multiple items of physical data including the “balance” field of the “Cust_Contr” dataset, the “rmb” field of the “Service_Agrmt” dataset, and any other existing or newly added datasets that are linked (or have technical metadata that are linked) to Remaining Balance.

In this manner, the techniques described herein combine analyses at the logical level and the physical level. The former amounts to a semantic and logical analysis to create a rule by physically linking items representing the rule. The latter amounts to applying the rule to verify if data complies therewith. The combination of both aspects provides an efficient implementation of generating and applying rules. In particular, the nodes that constitute the rule can be linked with further nodes when new rules are generated, as is described herein.

Although FIGS. 2A-2K illustrate examples in which the LLM selects a single candidate for an individual rule element during each iteration, the LLM can select multiple candidates for multiple rule elements in some examples. For example, the candidate set identification engine 104 may identify one or more sets of candidates for some or all of the rule elements, and the LLM may prompt the LLM to select candidate(s) for some or all of the rule elements from the one or more sets. In this manner, the rule may be generated in fewer iterations.

In some examples, the candidates provided to the LLM may be filtered based on, for example, a context of the requirements document (or the criteria specified by the requirements document). For example, one or more components of the selective LLM engine 102 may perform semantic analysis on the requirements document 200 to identify keywords, tags, or other features of the document or the criteria it contains, and then may filter the obtained candidates based on these identified keywords, tags, or other features to reduce the set of candidates provided to the LLM. In other examples, the LLM may interpret the requirements document and provide an indication as to what candidates are needed, which could then be used to filter the set of candidates provided for rule generation. In this manner, the number of candidates provided to the LLM may be reduced, thereby increasing computational efficiency and improving likelihood that the LLM provides an accurate response.

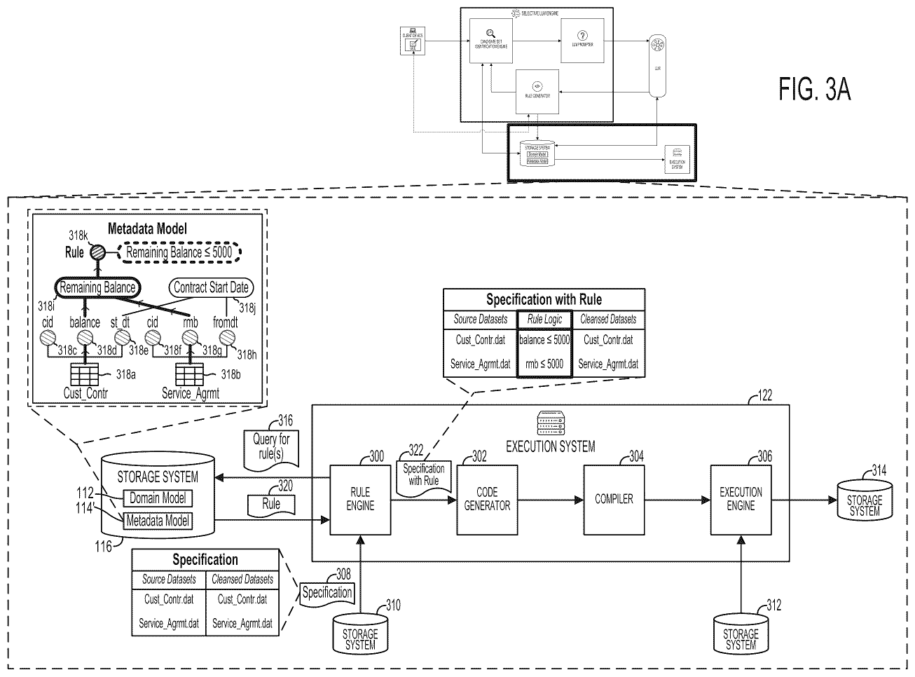

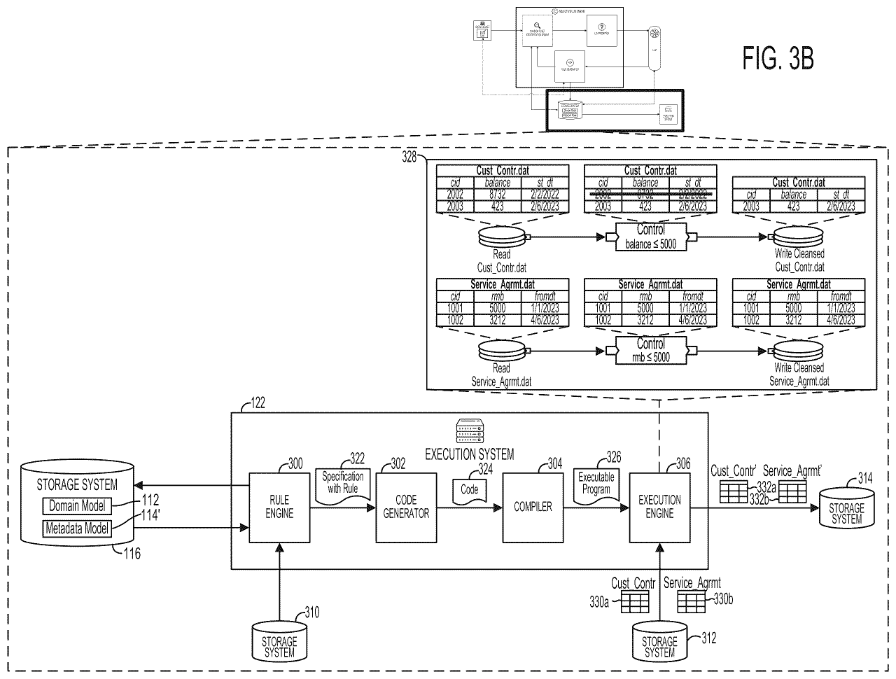

Referring to FIG. 3A, an example of application of a data governance rule is shown. In this example, the execution system 122 includes a rule engine 300, a code generator 302, a compiler 304, and an execution engine 306. The rule engine 300 is configured to use the metadata model 114′ to identify one or more rules that are applicable to data, and incorporate these rules into a data processing specification. The code generator 302 is configured to transform a data processing specification into code that can be compiled into executable instructions (e.g., an executable computer program) by the compiler 304 (or interpreted by an interpreter). The execution engine 306 is configured to execute the executable instructions in order to access data, process the data in accordance with rules describes herein, and store the data in storage.

Initially, the rule engine 300 of the execution system 122 receives a specification 308 from a storage system 310, though the specification can be received from other entities (e.g., the client device 110) without departing from the scope of the present disclosure. In general, the specification 308 includes instructions for processing data (e.g., accessing data, optionally transforming the data, and storing the (transformed) data). The specification 308 can be received in response to user input at the client device 110, at (pre-) determined times, or in response to various triggering events, such as changes to the metadata model 114 (e.g., due to creation of or change to a rule). In this example, the specification 308 includes instructions for accessing source datasets “Cust_Contr” and “Service_Agrmt” from storage system 312, and storing them as cleansed datasets in storage system 314. Storage systems 310, 312, and 314 can be the same or different storage systems. Moreover, in some examples, source datasets “Cust_Contr” and “Service_Agrmt” may be stored in disparate storage systems.

Upon receipt of the specification 308, the rule engine 300 processes the specification 308 to identify the items of data that are to be processed in accordance with the specification. For example, the rule engine 300 can process the specification 308 to extract technical metadata (e.g., dataset names, field names, etc.) representing the items of data that are to be accessed or otherwise processed in accordance with the specification. The rule engine 300 can then send a query 316 to the metadata model 114′ for rules associated with the extracted technical metadata. In this example, the query 316 includes a request for controls associated with the “Cust_Contr” and the “Service_Agrmt” datasets.

In response to the query 316, a data processing system associated with the metadata model 114′ (e.g., a data processing system associated with the storage system storing the metadata model 114′) traverses the metadata model 114′ to identify any rules that should be applied to the items of data represented in the query 316. In this example, the data processing system starts by accessing a dataset node 318a representing the “Cust_Contr” dataset. Accessing the dataset node 318a can include, for example accessing from hardware storage a data object or data structure that the node represents. Next, the edges associated with dataset node 318a can be followed to identify related nodes, such as the technical data element nodes 318c, 318d, 318e representing the “cid,” “balance,” and “st_dt” fields of the “Cust_Contr” dataset. For example, the dataset node 318a (or a separate edge data structure or object referenced by dataset node 318a) may include references to technical data element nodes 318c-318e, such as by including unique identifiers for technical data element nodes 318c-318e. In this case, following the edges can include identifying and accessing the technical data element nodes 318c-318e associated with the respective references (e.g., unique identifiers). In some examples, such as when the metadata model 114′ and its nodes are loaded into memory, dataset node 318a can include pointers to memory locations (e.g., memory addresses) for technical data element nodes 318c-318e, and following the edges can include accessing the technical data element nodes 318c-318e at the specified memory locations.

Similar processes can be followed to traverse other nodes in the metadata model 114′ and identify the applicable rules. For example, the edge associated with technical data element node 318d (representing the “balance” field) can be followed to identify and access logical data element node 318i (e.g., representing the “Remaining Balance” logical data element and thus associating this semantic meaning with the “balance” field). From here, the data processing system determines that node 318i is linked to rule node 318k, and thus identifies the rule “Remaining Balance≤5000” as a relevant rule for the query 316. The data processing system also identifies this rule through traversal of the “Service_Agrmt” (node 318b)-“rmb” (node 318g)-“Remaining Balance” (node 318i) path. As a result, rule data 320 specifying that the identified rule “Remaining Balance≤ 5000” is to be applied to the “balance” and “rmb” fields is returned to rule engine 300 in response to the query 316.

After receiving the rule data 320, the rule engine 300 updates the specification 308 to incorporate the rules and produce an updated specification 322. In this example, the rule engine 300 inserts an operation to check whether a record has a value in the “balance” field of the “Cust_Contr” dataset that is less than or equal to 5000, and another operation to check whether a record has a value in the “rmb” field of the “Service_Agrmt” dataset that is less than or equal to 5000.

The updated specification 322 is then sent to the code generator 302, as shown in FIG. 3B. The code generator 302 transforms the specification 322 into code 324, which is then compiled by the compiler 304 into an executable computer program 326 (e.g., an executable dataflow graph). In some examples, the executable computer program is generated using the techniques described in U.S. patent application Ser. No. 15/795,917, titled “Transforming a Specification into a Persistent Computer Program,” the entire content of which is incorporated herein by reference. In some examples, the code generator 302 and/or the compiler 304 may perform one or more optimizations to the specification 322, code 324, and/or the executable computer program 326, such as described in U.S. patent application Ser. No. 15/993,284, titled “Systems and Methods for Dataflow Graph Optimization,” the entire content of which is incorporated herein by reference. In some examples, the specification 322 may be transformed into code that can be executed through interpretation by an interpreter.

Updating the specification with operations thus prepares the specification for subsequent transforming of the specification into an executable program, which represents a technical effect: a document including natural language and natural language rules is transformed into an executable that can be used to physically enforce the rules on data. It is to be noted that the techniques described herein change the purpose of such a document from defining compliance or other rules to actual technical enforcement of such rules.

After generating the executable computer program 326, the execution engine 306 executes the executable to process physical data in conformance with the rule. As shown in the visualization 328, the execution engine 306 first reads the “Cust_Contr” dataset 330a and the “Service_Agrmt” dataset 330b. Then, the execution engine 306 checks whether “balance” is less than or equal to 5000 for each record in the “Cust_Contr” dataset, and whether “rmb” is less than or equal to 5000 for each record in the “Service_Agrmt” dataset. In this example, the record associated with “cid” 2002 in the “Cust_Contr” dataset has failed the rule, because the value of “balance” (8732) is not less or equal to 5000. As a result, the failed record is removed from the “Cust_Contr” dataset as part of the cleansing process, though other actions can be taken in some examples. Once execution is complete, the cleansed “Cust_Contr′” dataset 332a and the cleansed “Service_Agrmt′” dataset 332b are stored in the storage system 314. In this manner, a single rule defined at a logical level in the metadata model is automatically applied to multiple datasets from disparate sources. In some examples, the execution engine 306 can provide metadata resulting from the execution of the executable for storage. Such metadata can specify, for example, that three records passed the control while one record failed, and further specifies the reason for the failure. In some examples, the execution engine 306 can also update the metadata model 114′ with the cleansed datasets 332a, 332b, which can include adding nodes representing technical metadata the cleansed datasets and creating edges linking these nodes to related logical metadata. Updating the metadata model 114′ establishes a learning effect in that said model is enabled to apply the rule in future applications of the model. This effect is in addition to the transform and execution of the specification, described above.

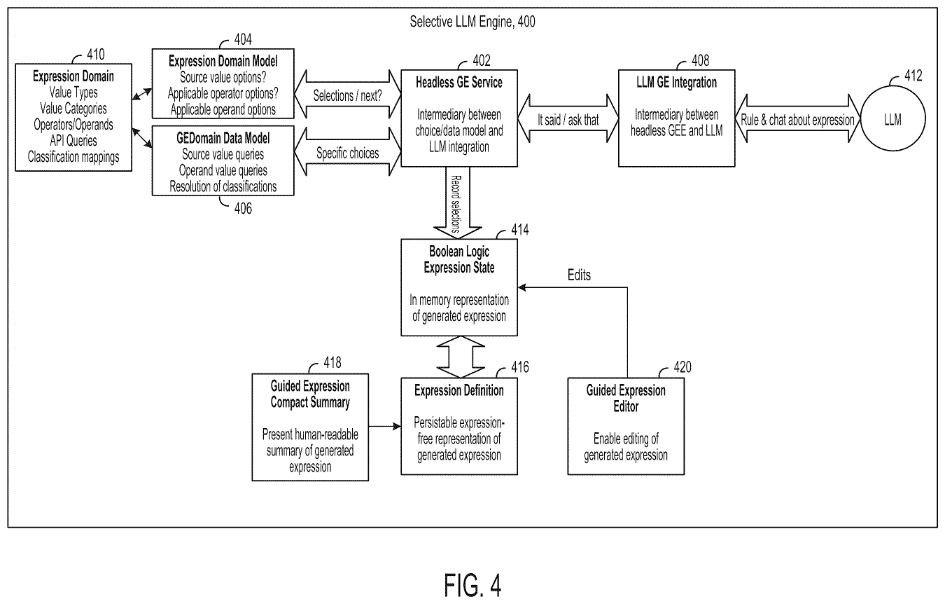

Referring to FIG. 4, a diagram of a selective LLM engine 400 is shown. The selective LLM engine 400 can be functionally the same as or similar to the selective LLM engine 102 shown in FIG. 1A. In this example, a headless guided expression (GE) service 402 acts as an intermediary between an expression domain model 404/GE domain data model 406, and an LLM GE integration 408. The headless GE service 402 interacts with the expression domain model 404 to provide selections from the LLM and to receive instructions on what should be asked of the LLM. The expression domain model 404 can be configured to answer questions such as what source value options are available, what are applicable operation options, or what are applicable operand options. To answer these questions, the expression domain model 404 can interact with an expression domain 410 that stores information about value types, value queries, operators, operands, metadata model queries (e.g., entity API queries), and classification mappings, among other data.

The headless GE service 402 also interacts with the GE domain data model 406 to receive specific choices for the questions presented to the LLM. To obtain these specific choices, the GE domain data model 406 can include queries to the expression domain 410 or another entity (e.g., the metadata model). Example queries can include source values queries, operand value queries, and resolution of classifications queries.

The headless GE service 402 and the LLM GE integration 408 exchange information (e.g., it said this/ask it that information) to “chat” with the LLM 412. The LLM GE integration 408 acts as an intermediary between the headless GE service 402 and the LLM 412 to exchange the business rule and the chat about the expression or rule. Note that the LLM 412 is external to the GE engine 400 in some examples.

The headless GE service 402 also records the LLM's selections to a Boolean logic expression state 414, which provides an in-memory representation of the generated expression or rule. An expression definition 416 receives the in-memory representation of the expression and generates a persistent, expression-free representation of the generated expression or rule. A guided expression compact summary 418 can present a human-readable summary of the generated expression or rule. Edits to the expression or rule can be received from a guided expression editor 420, as described herein.

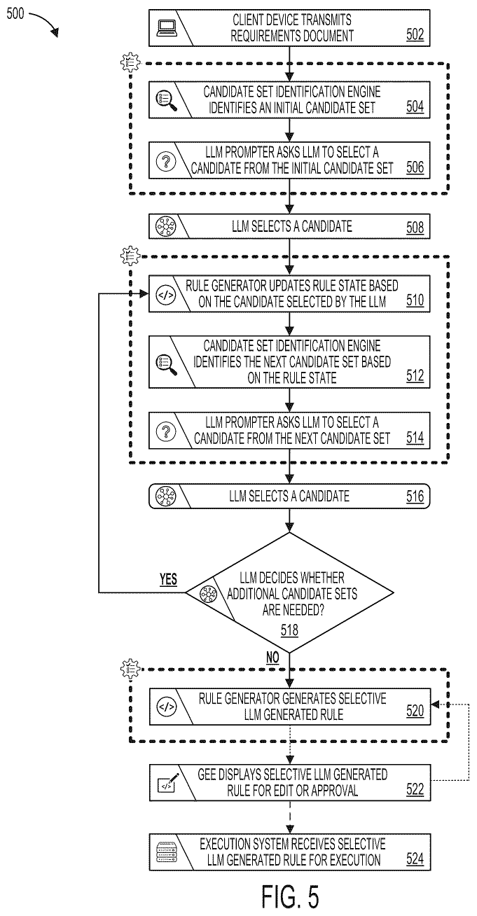

Referring to FIG. 5, a process 500 is shown for guiding a machine learning model (e.g., an LLM) in generating a rule. In some examples, the process 500 is performed by data processing system or one or more components of the system 100 shown in FIG. 1A. Operations of the process include a client device transmitting a requirements document to a candidate set identification engine of a selective LLM engine (502). The candidate set identification engine identifies an initial candidate set for generating a rule representing one or more requirements specified in the requirements document (504). An LLM prompter of the selective LLM engine prompts an LLM to select a candidate from the initial candidate set (506).

Responsive to the prompt, the LLM selects a candidate and provides an indication of the selected candidate to a rule generator of the selective LLM engine (508). The rule generator updates a rule state based on the candidate selected by the LLM (510). The rule state is provided to the candidate set identification engine, which identifies the next candidate set based on the rule state and interaction with a domain model (512). The LLM prompter receives the next candidate set and prompts the LLM to select a candidate from the next candidate set (514). Responsive to the prompt, the LLM selects a candidate (516).

The LLM determines whether additional candidate sets are needed to define the rule (518). If the LLM determines that additional candidate sets are needed, then the LLM provides the selected candidate to the rule generator along with an indication of the determination, and the process continues from step 510. On the other hand, if the LLM determines that no additional candidate sets are needed, then the LLM provides the selected candidate to the rule generator with an indication that no further candidate sets (or conditions) are required. The rule generator generates the selective LLM generated rule and provides it to the GEE (520). The GEE renders a user interface to display the selective LLM generated rule for edit or approval by a user (522). Any edits to the rule are provided to the rule generator, which updates the rule state and regenerates the rule. Otherwise, if the rule is approved, it is received (e.g., through update and traversal of a metadata model) by an execution system for execution (524).

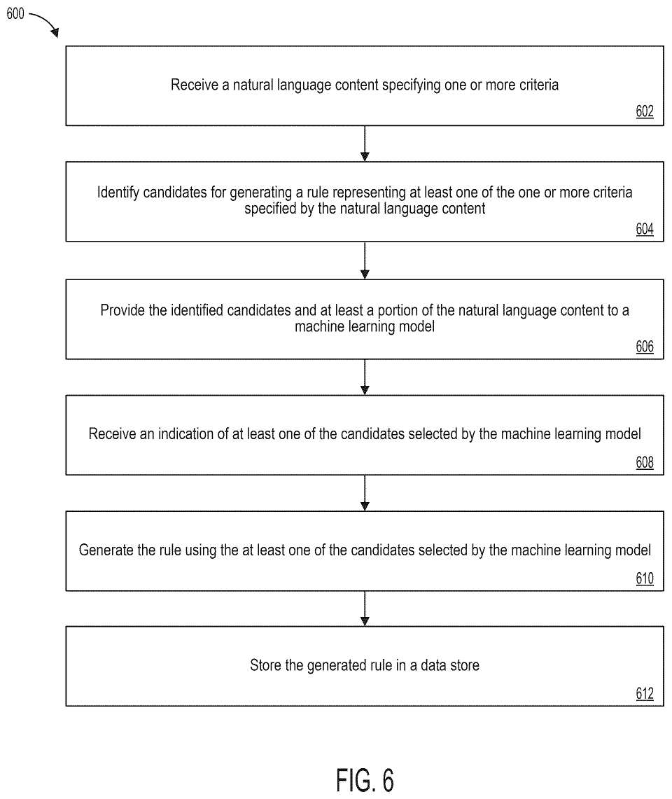

Referring to FIG. 6, a process 600 is shown for guiding a machine learning model in generating a rule. In some examples, the process 600 is performed by a data processing system or one or more components of the system 100 shown in FIG. 1A. Operations of the process 600 include receiving natural language content specifying one or more criteria (602). In some examples, the natural language content is read from a storage device. Candidates for generating a rule representing at least one of the one or more criteria specified by the natural language content are identified (604). In some examples, the identified candidates are read from a storage device. The identified candidates and at least a portion of the natural language content are provided to a machine learning model (606). In some examples, the identified candidates and the portion of the content are stored by a storage device. An indication of at least one of the candidates selected by the machine learning model is received (608). In some examples, the indication is read from a storage device. The rule is generated using the at least one of the candidates selected by the machine learning model (610). The generated rule is stored in a data store (612).

As described herein, dataflow graph components include data processing components and/or datasets. A dataflow graph can be represented by a directed graph that includes nodes or vertices, representing the dataflow graph components, connected by directed links or data flow connections, representing flows of work elements (i.e., data) between the dataflow graph components. The data processing components include code for processing data from at least one data input (e.g., a data source), and providing data to at least one data output (e.g., a data sink), of a system. The dataflow graph can thus implement a graph-based computation performed on data flowing from one or more input datasets through the graph components to one or more output datasets.

A system also includes a data processing system for executing one or more computer programs (such as dataflow graphs), which were generated by the transformation of a specification into the computer program(s) using a transform generator and techniques described herein. The transform generator transforms the specification into the computer program. In this example, the selections made by user through the user interfaces described here form a specification that specify which data sources to ingest. Based on the specification, the transforms described herein are generated.

The data processing system may be hosted on one or more general-purpose computers under the control of a suitable operating system, such as the UNIX operating system. For example, the data processing system can include a multiple-node parallel computing environment including a configuration of computer systems using multiple central processing units (CPUs), either local (e.g., multiprocessor systems such as SMP computers), or locally distributed (e.g., multiple processors coupled as clusters or MPPs), or remotely distributed (e.g., multiple processors coupled via LAN or WAN networks), or any combination thereof.

The graph configuration approach described above can be implemented using software for execution on a computer. For instance, the software forms procedures in one or more computer programs that execute on one or more systems, e.g., computer programmed or computer programmable systems (which may be of various architectures such as distributed, client/server, or grid) each including at least one processor, at least one data storage system (including volatile and non-volatile memory and/or storage elements), at least one input device or port, and at least one output device or port. The software may form one or more modules of a larger computer program, for example, that provides other services related to the design and configuration of dataflow graphs. The nodes and elements of the graph can be implemented as data structures stored in a computer readable medium or other organized data conforming to a data model stored in a data repository.

The software may be provided on a non-transitory storage medium, such as a hardware storage device (e.g., a CD-ROM), readable by a general or special purpose programmable computer or delivered (encoded in a propagated signal) over a communication medium of a network to the computer where it is executed. All of the functions may be performed on a special purpose computer, or using special-purpose hardware, such as coprocessors. The software may be implemented in a distributed manner in which different parts of the dataflow specified by the software are performed by different computers. Each such computer program is preferably stored on or downloaded to a non-transitory storage media or hardware storage device (e.g., solid state memory or media, or magnetic or optical media) readable by a general or special purpose programmable computer, for configuring and operating the computer when the non-transitory storage media or device is read by the system to perform the procedures described herein. The system may also be considered to be implemented as a computer-readable storage medium, configured with a computer program, where the storage medium so configured causes the system to operate in a specific and predefined manner to perform the functions described herein.

### Example Computing Environment

Referring to FIG. 7, an example operating environment for implementing embodiments of the present invention is shown and designated generally as computing device 700. Essential elements of a computing device 700 or a computer or data processing system or client or server are one or more programmable processors 702 for performing actions in accordance with instructions and one or more memory devices 704 for storing instructions and data. Generally, a computer will also include, or be operatively coupled, (via bus 701, fabric, network, etc.,) to I/O components 706 (e.g., display devices, network/communication subsystems, etc. (not shown) and one or more mass storage devices 708 for storing data and instructions, etc.), and a network communication subsystem 710, which are powered by a power supply (not shown). In memory 704, are an operating system 704a and applications 704b for application programming.

Devices suitable for storing computer program instructions and data include all forms of non-volatile memory, media and memory devices including by way of example, semiconductor memory devices (e.g., EPROM, EEPROM, and flash memory devices), magnetic disks (e.g., internal hard disks or removable disks), magneto optical disks, and CD ROM and DVD-ROM disks. The processor and the memory can be supplemented by, or incorporated in, special purpose logic circuitry.

To provide for interaction with a user, embodiments of the subject matter described in this specification are implemented on a computer having a display device (monitor) for displaying information to the user and a keyboard, a pointing device, (e.g., a mouse or a trackball) by which the user can provide input to the computer. In addition, a computer can interact with a user by sending documents to and receiving documents from a device that is used by the user (for example, by sending web pages to a web browser on a user's user device in response to requests received from the web browser).

Embodiments of the subject matter described in this specification can be implemented in a computing system that includes a back end component (e.g., as a data server), or that includes a middleware component (e.g., an application server), or that includes a front end component (e.g., a user computer having a graphical user interface or a Web browser through which a user can interact with an implementation of the subject matter described in this specification), or any combination of one or more such back end, middleware, or front end components. The components of the system can be interconnected by any form or medium of digital data communication (e.g., a communication network). Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the user device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described above should not be understood as requiring such separation in all embodiments, and it should be understood that the described program components and systems can generally be integrated together in a single software product or packaged into multiple software products.

A number of embodiments have been described. Nevertheless, it will be understood that various modifications may be made without departing from the spirit and scope of the techniques described herein. For example, some of the steps described above may be order independent, and thus can be performed in an order different from that described. Additionally, any of the foregoing techniques described with regard to a dataflow graph can also be implemented and executed with regard to a program. Accordingly, other embodiments are within the scope of the following claims.

What is claimed is:

1. A method implemented by a data processing system for dynamically and automatically guiding a machine learning model in generating a rule from natural language content by controlling the machine learning model to select from candidates that will enable the rule to operate efficiently, including:
reading, from a storage device, natural language content specifying one or more criteria;
reading, from a storage device, identified candidates for generating a rule representing at least one of the one or more criteria specified by the natural language content;
storing, by a storage device, the identified candidates and at least a portion of the natural language content for transmission to a machine learning model;
reading, from a storage device, an indication of at least one of the candidates selected by the machine learning model; and
storing, by a storage device, the rule using the at least one of the candidates selected by the machine learning model.

2. A method implemented by a data processing system for dynamically and automatically guiding a machine learning model in generating a rule from natural language content by controlling the machine learning model to select from candidates that will enable the rule to operate efficiently, including:
receiving, by a data processing system, natural language content specifying one or more criteria;
identifying, by a data processing system, candidates for generating a rule representing at least one of the one or more criteria specified by the natural language content;
providing, by a data processing system, the identified candidates and at least a portion of the natural language content to a machine learning model;
receiving, by a data processing system, an indication of at least one of the candidates selected by the machine learning model;
generating, by a data processing system, the rule using the at least one of the candidates selected by the machine learning model; and
storing, in a data store, the generated rule.

3. The method of claim 2, wherein the candidates include first candidates, the method including:
identifying, based on the at least one of the first candidates selected by the machine learning model, second candidates for generating the rule representing the at least one of the one or more criteria specified by the natural language content;
providing the identified second candidates to the machine learning model;
receiving an indication of at least one of the second candidates selected by the machine learning model; and
generating the rule using the at least of the first candidates and the at least one of the second candidates selected by the machine learning model.

4. The method of claim 3, wherein identifying the second candidates for generating the rule includes:
querying a domain model for the second candidates based on one or more attributes of the at least one of the first candidates selected by the machine learning model; and
receiving the second candidates in response to the query.

5. The method of claim 4, including:
determining at least one first characteristic of the at least one of the first candidates selected by the machine learning model;
determining at least one second characteristic that is associated with the at least one first characteristic; and
identifying, using the domain model and from a plurality of candidates, the second candidates based on the at least one second characteristic, wherein each of the second candidates are associated with the at least second characteristic.

6. The method of claim 2, wherein the candidates for generating the rule specify at least one of a value, an operator, an operand, or a function.

7. The method of claim 2, wherein identifying the candidates for generating the rule includes:
determining a context of the at least one of the one or more criteria specified by the natural language content;
filtering a plurality of candidates based on the context; and
identifying, from the filtered plurality of candidates, the candidates for generating the rule.

8. The method of claim 7, wherein the context is determined based on information received from the machine learning model or based on semantic analysis of the natural language content.

9. The method of claim 2, wherein identifying the candidates for generating the rule includes:
querying a metadata model for one or more items of metadata, wherein the one or items of metadata specify a semantic meaning of data; and
receiving the one or more items of metadata in response to the query, wherein the candidates for generating the rule include the one or more items of metadata.

10. The method of claim 2, including:
based on the natural language content, generating a prompt for the machine learning model, with the prompt specifying the candidates for generating the rule; and
providing the prompt to the machine learning model.

11. The method of claim 2, including:
receiving, from the machine learning model, a request for information associated with one or more of the candidates; and
providing, to the machine learning model, the requested information.

12. The method of claim 2, including:
generating user interface data that when rendered on a display device displays a user interface with a visual representation of the generated rule.

13. The method of claim 12, including:
receiving a request to edit the generated rule; and
in response to the request, generating second user interface data that when rendered on a display device displays a second user interface including one or more valid choices for editing the rule.

14. The method of claim 13, wherein the one or more valid choices specify one or more of the candidates for generating the rule.

15. The method of claim 2, including:
updating a metadata model to associate the generated rule with an item of metadata associated with the at least one of the candidates identified.

16. The method of claim 15, wherein updating the metadata model includes:
adding, to the metadata model, a node representing the generated rule and an edge linking the node to another node representing the item of metadata.

17. The method of claim 16, wherein the metadata model includes a plurality of data structures stored in data storage, wherein the node includes a first one of the data structures representing the generated rule, and wherein the edge includes a reference in the first one of the data structures to a second one of the data structures representing the item of metadata.

18. The method of claim 16, including:
receiving a data processing specification that specifies at least one item of data;
identifying, based on the metadata model, that the at least one item of data is associated with the item of metadata associated with the generated rule; and
updating the data processing specification to include the generated rule.

19. The method of claim 18, including:
generating an executable computer program based on the updated data processing specification; and
executing the executable computer program to process the at least one item of data in accordance with the generated rule.

20. The method of claim 2, wherein the machine learning model includes a large language model.

21. A non-transitory computer-readable storage medium storing instructions executable by one or more processors to cause the one or more processors to perform operations including:
receiving natural language content specifying one or more criteria;
identifying candidates for generating a rule representing at least one of the one or more criteria specified by the natural language content;
providing the identified candidates and at least a portion of the natural language content to a machine learning model;
receiving an indication of at least one of the candidates selected by the machine learning model;
generating the rule using the at least one of the candidates selected by the machine learning model; and
storing the generated rule.
